(19) United States
(12) Patent Application Publication
(10) Pub. No.: US 2009/0159144 A1
(43) Pub. Date: Jun. 25, 2009

(54) FLEXIBLE PIPES

(76) Inventor: Keith Dixon-Roche, Devon (GB)

Correspondence Address: HOWREY LLP-EU, C/O IP DOCKETING DEPARTMENT, 2941 FAIRVIEW PARK DR., SUITE 200, FALLS CHURCH, VA, 22042, US

(21) Appl. No.: 12/065,244

(22) PCT Filed: Sep. 4, 2006
(86) PCT No.: PCT/GB06/03256

§ 371 Date: Nov. 3, 2008

(30) Foreign Application Priority Data
Sep. 3, 2005 (GB) 0517998.1

(51) Int. Cl. F16L 53/00; F16L 59/147; F16L 11/08

(52) U.S. Cl. 138/33; 138/149; 138/153; 138/174; 138/135; 138/127; 138/139

(57) ABSTRACT

The invention relates to flexible pipes for transporting cryogenic gas in liquefied form. The pipe is of composite form and comprises an inner pipe adapted to withstand pressure loads and cryogenic temperatures, an outer pipe adapted to withstand tensile axial forces, and a layer of insulating material (34) interposed between the inner and outer pipes. The inner pipe is defined by a hollow carcass (10) formed from a helical interlocked metallic strip (12), the internal and external surfaces of which are lined with a fluid-pressure containment sheath (32) of fully fluorinated fluoroplastic. The insulating layer (34) acts to maintain a temperature differential between the respective pipes. Adjacent portions of the strip (12) in the carcass (10) are moveable relative to each other to provide flexibility to the pipe along its length.

The present inventions relates to flexible pipes and particularly, but not exclusively, to flexible pipes for carrying cryogenic fluids.

Until recently, the transportation of cryogenic fluids, such as liquefied natural gas (LNG), necessitated the use of rigid pipes. This is because most flexible materials suffer embrittlement at typical cryogenic-fluid temperatures of approximately −190° C. Accordingly, known cryogenic-fluid transfer pipes commonly use one or more inner layers of tough stainless steel surrounded by insulation and protected by an outer coating of protective material, e.g. concrete.

In the context of the present invention, a pipe is understood to be “rigid” if its bend radius is at least 2.23 orders of magnitude greater than its outside diameter. For example, by deforming a rigid pipe comprising a steel or rigid plastics material to a bend radius less than 230 times its outside diameter would tend to compromise the elastic limit of its constituent materials.

Conversely, in the context of the present invention, a pipe is understood to be “flexible” if its bend radius is below 2.23 orders of magnitude greater than its outside diameter. However, preferably, the bend radius of a flexible pipe will be less than 1.5 orders of magnitude greater than its outside diameter. For example, flexible pipes will readily deform to a bend radius of 10-50 times their outside diameter without deforming any of their constituent materials beyond their elastic limit.

The problems inherent in the use of rigid pipes are as follows: (i) steel becomes dangerously brittle at typical cryogenic-fluid temperatures; (ii) deployment of a rigid pipe between two relatively moving vessels (i.e. during ship-to-ship or ship-to-installation transfer) is difficult and requires the use of complex swivel joints; and (iii) relatively small bore rigid pipes employing high density materials cannot be floated on the surface of water.

Whilst various pipes for the transfer of cryogenic fluids have been proposed in an effort to address the aforementioned problems, such known pipes are complex and/or expensive and/or exhibit an insufficient degree of flexibility, particularly for use in exposed marine environments, and therefore fail to provide practical solutions.

According to a first aspect of the present invention, there is provided a flexible pipe for transporting cryogenic gas in liquefied form, said pipe being of composite construction and comprising:
(i) an inner pipe adapted to withstand pressure loads and cryogenic temperatures, the inner pipe defined by a hollow carcass formed from interlocked metallic strip, and a fluid-pressure containment sheath of fluorinated fluoroplastic lining a surface of the carcass;
(ii) an outer pipe adapted to withstand tensile axial loads; and
(iii) a layer of insulating material interposed between the inner and outer pipes, the insulating layer being adapted to maintain a temperature differential between the respective pipes;
wherein adjacent portions of the strip in the carcass are moveable relative to each other to provide flexibility to the pipe along its length.

Preferably, the interlocked metallic strip is helical.

Preferably, opposing edges of the helical metallic strip are folded into interlocking engagement.

Preferably, the helical metallic strip defines a series of substantially planar internal and external surfaces in the longitudinal direction of the carcass, the substantially planar surfaces being interrupted by indentations corresponding to the position of the folds.

Optionally, a fluid-pressure containment sheath only contacts the substantially planar parts of one or both of the respective internal and external surfaces of the carcass.

Optionally, a fluid-pressure containment sheath contacts the entire surface of one or both of the internal and external surfaces of the carcass.

Optionally, a fluid-pressure containment sheath only contacts the substantially planar parts of one of the internal and external surfaces of the carcass whilst another fluid-pressure containment sheath contacts the entire surface of the other of the internal and external surfaces of the carcass.

Optionally, a filler material is provided behind the fluid-pressure containment sheath contacting only the substantially planar parts of one or both of the internal and external surfaces of the carcass.

Preferably, the filler material is silicone rubber.

Optionally, the insulating layer is a flexible aerogel-based material.

Preferably, the outer carrier pipe comprises an elastomer layer which surrounds the insulating layer.

Optionally, pipe heating means are provided within the elastomer layer.

Preferably, a steelcord reinforcement layer is embedded within the elastomer to provide the resistance to tensile axial loads.

Optionally, a cover layer formed from chlorosulfonated polyethylene rubber (Hypalon®) surrounds the outer carrier pipe.

Alternatively, the cover layer is formed from Acrylonitrile-Butadiene Rubber (NBR), Hydrogenated Acrylonitrile-Butadiene Rubber (HNBR), Polybutadyene (PR) or natural rubber.

Optionally, pipe heating means are provided within the cover layer.

Preferably, a layer of polyethylene is provided as an external layer.

Preferably, the polyethylene is Ultra-High Molecular Weight Polyethylene (UhmwPe).

Preferably, the carcass is formed from a stainless steel.

Preferably, the stainless steel remains tough at temperatures below −160° C.

Preferably, the stainless steel is a nickel-based alloy.

Preferably, the nickel-based alloy is Inconel®.

Preferably, the fluorinated fluoroplastic sheath is fully fluorinated.

Preferably, the fully fluorinated fluoroplastic is Fluorinated Ethylene Propylene (FEP), Polytetrafluoroethylene (PTFE), Perfluoroalkoxy polymer resin (PFA) or Perfluoroalkoxy (MFA).

According to a second aspect of the present invention, there is provided a method of manufacturing a flexible pipe for transporting cryogenic fluid, the method comprising the steps of:
(i) providing a hollow metallic carcass defined by a plurality of inter-engaging links;
(ii) lining a surface of the carcass with a fluorinated fluoroplastic to define an inner pipe;
(iii) surrounding the carcass with a layer of insulating material; and
(iv) surrounding the layer of insulating material with an outer pipe;
   wherein the inner pipe is adapted to withstand pressure stresses and cryogenic temperatures, and the outer pipe is adapted to withstand tensile stresses.

According to a third aspect of the present invention, there is provided a method of connecting two pipe terminations to facilitate the transportation of cryogenic fluid between the two, the method comprising the steps of:
(i) providing a flexible pipe in accordance with the first aspect; and
(ii) connecting the pipe at its distal ends to the pipe terminations.

Embodiments of the invention will now be described, by way of example only, with reference to the accompanying drawings, in which:

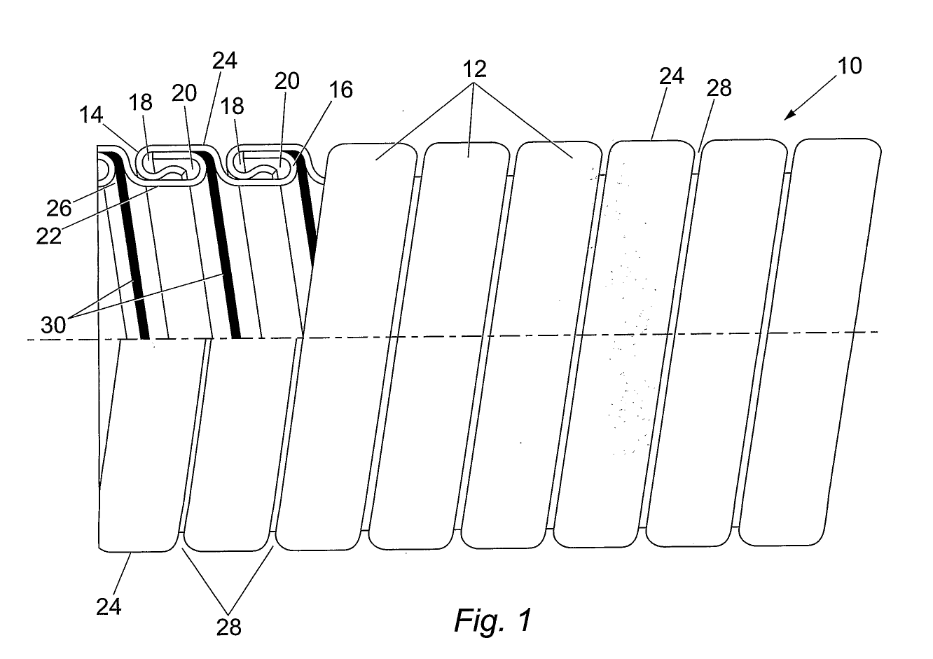

FIG. 1 is a front view of the carcass partially cut away to show the interlocked metallic strip;

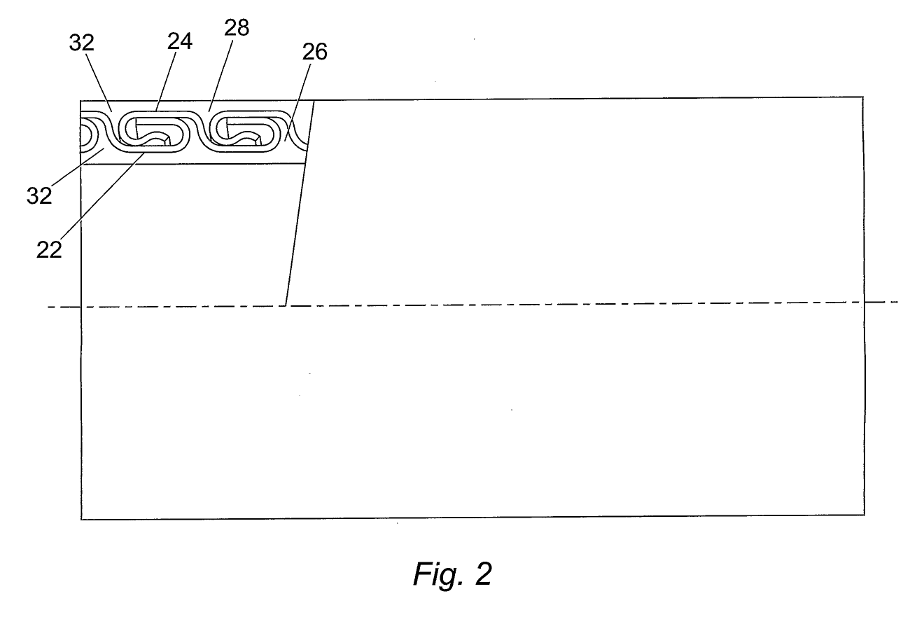

FIG. 2 is a front view of the carcass lined with a fluid-pressure containment sheath and partially cut away to show that the fluid-pressure containment sheath contacts the entire surface of both the internal and external surfaces of the carcass;

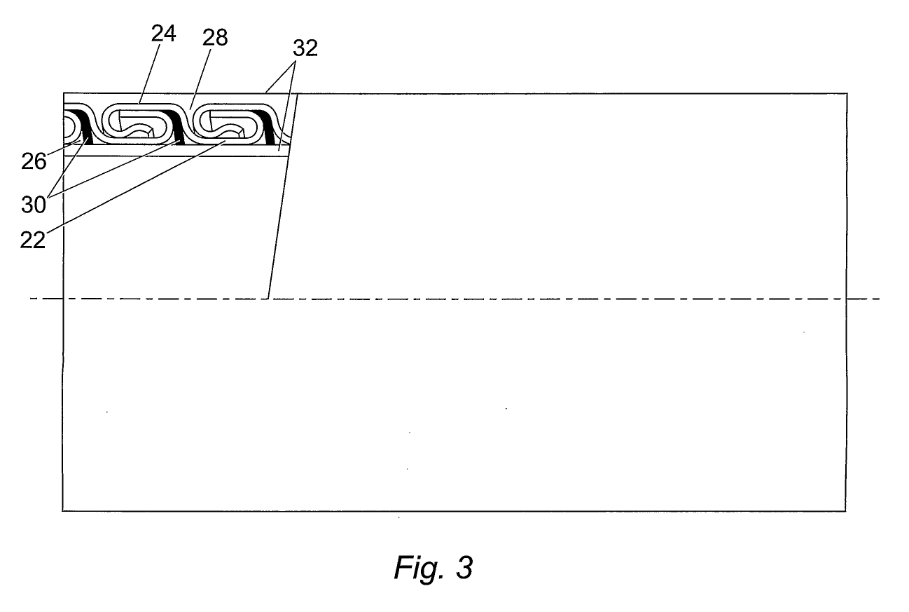

FIG. 3 is similar to FIG. 2 except that the fluid-pressure containment sheath contacts the entire surface of the external surface of the carcass whilst only contacting the planar parts of its internal surface;

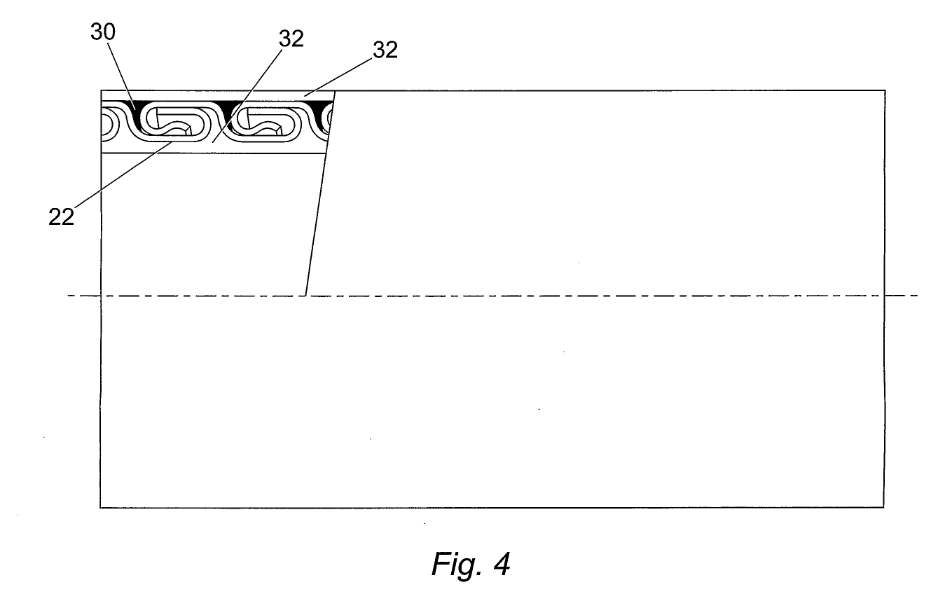

FIG. 4 is the mirror to FIG. 3 in that the fluid-pressure containment sheath contacts the entire surface of the internal surface of the carcass whilst only contacting the planar parts of its external surface;

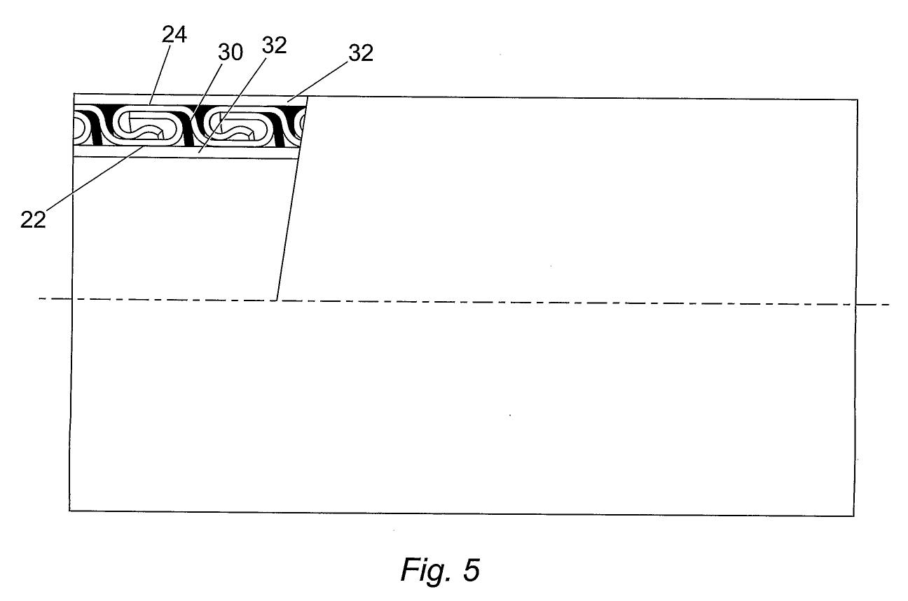

FIG. 5 is similar to FIG. 2 except that the fluid-pressure containment sheath contacts only the planar parts of both the internal and external surfaces of the carcass;

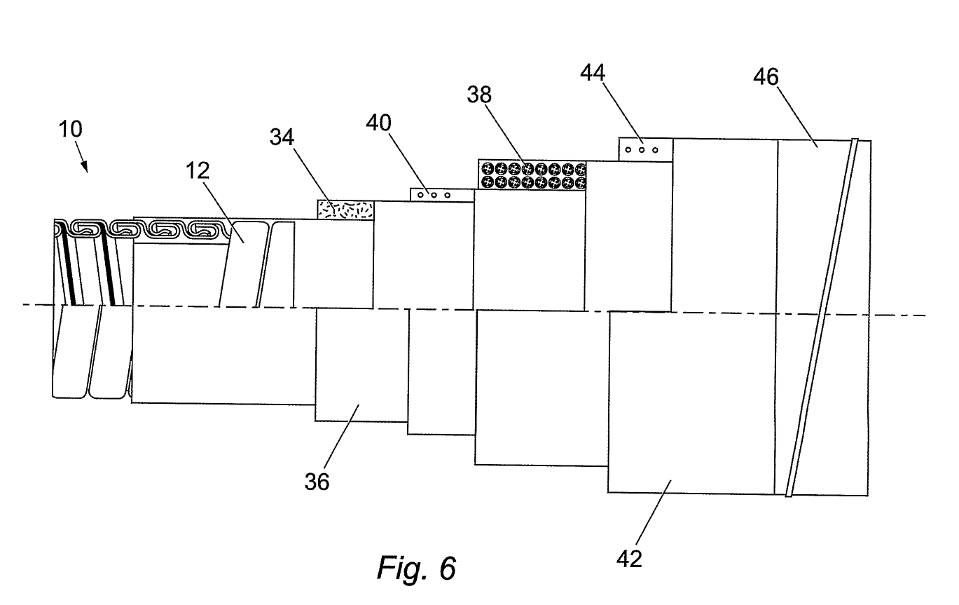

FIG. 6 is a side view of the flexible pipe in which its various constituent layers are progressively added and showing various cut away sections; and

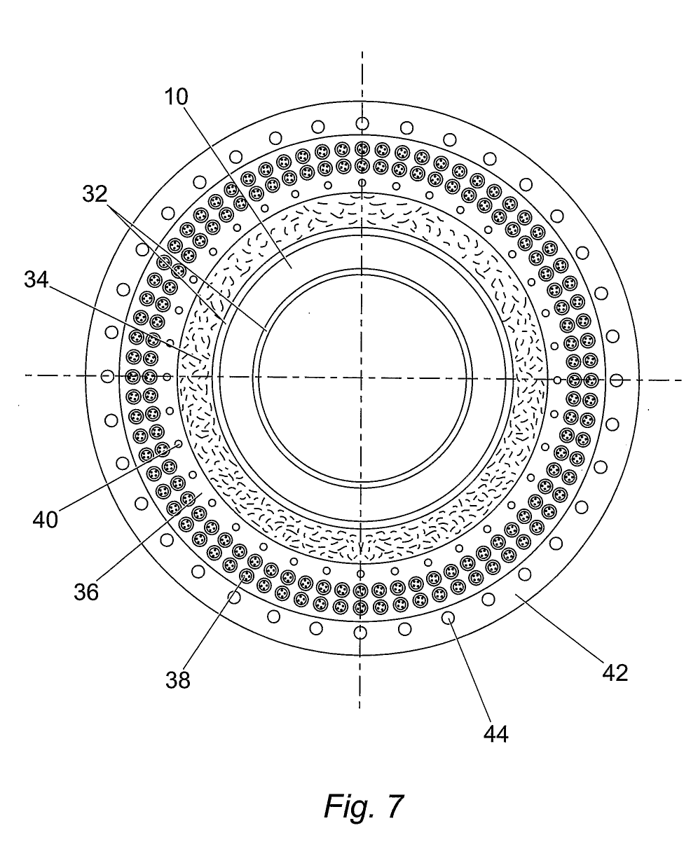

FIG. 7 is an end sectional view of the flexible pipe.

The flexible pipe of the present invention is of a composite bonded or unbonded pipe-in-pipe construction having an inner production pipe within an outer carrier pipe. The inner production pipe is adapted to withstand cryogenic temperatures and pressure loads (internal and external), and the outer carrier pipe is adapted to withstand the tensile axial loads experienced during its installation and service.

Part of the inner production pipe is shown in FIG. 1 and comprises a hollow carcass (10) made up of a continuous helical stainless steel strip (12). The opposing edges (14, 16) of the strip (12) are folded at an angle of 180 degrees to form two opposed U-shaped channels (18, 20). The width of channel (18) varies along its depth whereas the width of channel (20) is substantially constant along its depth. The strip (12) adopts a general S-shape in cross-section.

The strip (12) is interlocked such that its edge (14) nests within channel (20) and its edge (16) nests within channel (18). The interlocked strip (12) defines a series of substantially planar (in the longitudinal direction of the carcass) internal and external surfaces (22, 24) of the carcass (10). The adjacent internal surfaces (22) and adjacent external surfaces (24) are each interrupted by respective internal and external indentations (26, 28) corresponding to the position of the folds in the opposing edges (14, 16). The internal and external indentations (26, 28) extend along the length of the pipe in a helical fashion. A filler material (30) of silicone rubber material is optionally provided within one or both of the internal and external indentations (26, 28) to provide resistance to deformation as described below.

Neighbouring portions of the strip (12) are therefore capable of a degree of movement relative to one another in the radial direction such that a small amount of movement between neighbouring portions translates into a relatively larger amount of potential bending of the pipe over a given length.

The stainless steel material of the carcass (10) is preferably a nickel-based alloy such as Inconel®. However, it will be appreciated that other stainless steel materials capable of remaining tough at temperatures below −160° C. could equally be employed, e.g. austenitic stainless steels.

FIGS. 2-5 each show one of four possible constructions of an inner production pipe comprising fluid-pressure containment sheaths (32) which line the interior and exterior surfaces of the carcass (10). Each fluid-pressure containment sheath (32) is formed from a fully fluorinated fluoroplastic material such as Fluorinated Ethylene Propylene (FEP), Polytetrafluoroethylene (PTFE), Perfluoroalkoxy polymer resin (PFA) or Perfluoroalkoxy (MFA).

In FIG. 2, each sheath (32) contacts the entire surface of both the internal and external surfaces (22, 24) of the carcass (10), including the surfaces of the internal and external indentations (26, 28). The carcass (10) is therefore fully encased in the fully fluorinated fluoroplastic material.

In FIG. 3, one sheath (32) contacts the entire surface of the external surface (24) of the carcass (10), including the surfaces of the external indentations (28). Therefore, only the external surface (24) of the carcass (10) is fully encased in the fully fluorinated fluoroplastic material.

Meanwhile, a second sheath (32) contacts only the substantially planar surfaces (22) of the internal surface, but not the surfaces of the internal indentations (26). The second sheath (32) therefore defines a continuous inner helical void along the length of the pipe which, in the example shown in FIG. 3, is filled with a filler material (30) such as silicone rubber. The silicone rubber may be introduced into the helical void after the second sheath (32) is applied to the inner surface (22) of the carcass (10) by injecting it through the second sheath (32). The silicone rubber supports the sheath (32) so as to provide a resistance to deformation arising due to pressure differentials.

The construction of the inner production pipe shown in FIG. 4 is the mirror image of that of FIG. 3 in that it is only the internal surface (22) of the carcass (10) which is fully encased by a sheath (32) whilst only the substantially planar surfaces (24) of the external surface are contacted by another sheath (32). Similarly, a silicone rubber (30) fills the outer helical void along the length of the pipe.

In FIG. 5, neither of the internal or external surfaces (22, 24) is fully encased by a sheath (32). Instead, only the substantially planar surfaces (22, 24) are contacted by the respective sheaths (32) to therefore define continuous inner and outer helical voids along the length of the pipe. In the example shown in FIG. 5, both voids are filled by the silicone rubber material.

The carcass (10) and each fluid-pressure containment sheath (32) form a flexible inner production pipe which is also shown at the left hand side of FIG. 6. Interposed between the inner production pipe and the outer carrier pipe (described in detail below) is a flexible layer of insulating material (34) which may be formed from an aerogel-based material. The purpose of the insulating material (34) is to insulate the inner production pipe from the relatively higher temperatures experienced by the outer carrier pipe, the outer carrier pipe being exposed to ambient temperatures, e.g. sea temperature. The insulating material (34) must remain flexible and be capable of withstanding hoop stresses induced by the reinforcement layer (described below) when it is under axial load.

The innermost layer of the outer carrier pipe is formed from an elastomeric material (36) which remains deformable at temperatures of approximately −50° C. A reinforcement layer (38) is embedded within and fully bonded to the elastomeric layer (36) (i.e. an LT-50 elastomer) to provide resistance to the tensile (axial) loads experienced during the pipe's installation and service. Such loads may exceed five tonnes. The reinforcement layer (38) comprises a series of parallel strands of steelcord wrapped around the pipe in a helical fashion at any suitable angle (i.e. that which gives the best resistance to tension according to the axial loads imposed on the pipe) and at any suitable packing density (depending upon the required strength of the pipe). Depending upon the particular tensile axial loads involved, the reinforcement layer may also be formed from strands of steel wire or flat strip. Alternative materials such as textiles (e.g. yarn, aramid fibre, silk, etc.), polymers (e.g. nylon, polypropylene, etc.) or carbon fibre may be used to form the strands of the reinforcement layer (38).

In an alternative arrangement (not shown) steelcord may be applied in the longitudinal direction of the pipe in addition to the helical direction so as to limit the longitudinal growth of the pipe. A similar effect can be achieved by increasing the angle of the steelcord.

Heating elements (40) can be provided within the elastomeric layer (36). In the particular example shown in FIG. 6, the heating elements (40) are interposed between the insulating material (34) and the reinforcement layer (38) and are arranged to maintain the temperature of the elastomeric layer (36) above −50° C. so as to ensure that it remains sufficiently deformable.

The elastomeric layer (36) is covered by an impact resistant layer (42) of chlorosulfonated polyethylene rubber (Hypalon®), Acrylonitrile-Butadiene Rubber (NBR), Hydrogenated Acrylonitrile-Butadiene Rubber (HNBR), Polybutadyene (PR) or natural rubber. This layer provides protection from external impact loads and may also have further heating elements (44) embedded within it to maintain the temperature of the impact resistant layer (42) above 0° C. (i.e. above the freezing temperature of sea water).

Finally, an outer layer (46) of polyethylene is provided as an external layer to increase resistance to scuffing. A particularly appropriate material in this regard is an Ultra-High Molecular Weight Polyethylene (UhmwPe).

All layers of the respective inner and outer pipes are also shown in FIG. 7.

The flexible pipe of the present invention provides a simpler and therefore more cost-effective solution to the problems inherent in prior art pipes by making use of cheaper materials and a smaller amount of materials per unit length. The flexible pipe of the present invention is therefore also simpler to manufacture. Moreover, the flexible pipe of the present invention allows an increased degree of flexibility of both the inner production pipe and the outer carrier pipe whilst withstanding typical levels of internal/external pressure stresses and tensile stresses experienced by such pipes.

Modifications and improvements may be made to the foregoing without departing from the scope of the invention. For example, the helical metallic strip can be formed from a series of discrete partial helices joined together in series (for example by welding) to form a carcass of a given length. Alternatively, the interlocked metallic strip can be formed into a series of discrete annular links which are interconnected at their peripheral edges to form a hollow carcass.

1. A flexible pipe for transporting cryogenic gas in liquefied form, said pipe being of composite construction and comprising:
(i) an inner pipe adapted to withstand pressure loads and cryogenic temperatures, the inner pipe defined by a hollow carcass formed from an interlocked metallic strip, and a fluid-pressure containment sheath of fluorinated fluoroplastic lining a surface of the carcass;
(ii) an outer pipe adapted to withstand tensile axial forces; and
(iii) a layer of insulating material interposed between the inner and outer pipes, the insulating layer being adapted to maintain a temperature differential between the respective pipes; wherein adjacent portions of the strip in the carcass are moveable relative to each other to provide flexibility to the pipe along its length.

2. A pipe as claimed in claim 1, wherein the interlocked metallic strip is helical.

3. A pipe as claimed in claim 2, wherein opposing edges of the helical metallic strip are folded into interlocking engagement.

4. A pipe as claimed in claim 3, wherein the helical metallic strip defines a series of substantially planar internal and external surfaces in the longitudinal direction of the carcass, the substantially planar surfaces being interrupted by indentations corresponding to the position of the folds.

5. A pipe as claimed in claim 4, wherein a fluid-pressure containment sheath only contacts the substantially planar parts of one or both of the respective internal and external surfaces of the carcass.

6. A pipe as claimed in claim 4, wherein a fluid-pressure containment sheath contacts the entire surface of one or both of the internal and external surfaces of the carcass.

7. A pipe as claimed in claim 4, wherein a fluid-pressure containment sheath only contacts the substantially planar parts of one of the internal and external surfaces of the carcass whilst another fluid-pressure containment sheath contacts the entire surface of the other of the internal and external surfaces of the carcass.

8. A pipe as claimed in claim 5, wherein a filler material is provided behind the fluid-pressure containment sheath contacting only the substantially planar parts of one or both of the internal and external surfaces of the carcass.

9. A pipe as claimed in claim 8, wherein the filler material is silicone rubber.

10. A pipe as claimed in claim 1, wherein the insulating layer is a flexible aerogel-based material.

11. A pipe as claimed in claim 1, wherein the outer carrier pipe comprises an elastomer layer which surrounds the insulation layer.

12. A pipe as claimed in claim 11, wherein pipe heating elements are provided within the elastomer layer.

13. A pipe as claimed in claim 11, wherein a steelcord reinforcement layer is embedded within the elastomer to provide the resistance to tensile loads.

14. A pipe as claimed in claim 1, wherein a cover layer of chlorosulfonated polyethylene rubber (Hypalon®) surrounds the outer carrier pipe.

15. A pipe as claimed in claim 14, wherein the cover layer is formed from Acrylonitrile-Butadiene Rubber (NBR), Hydrogenated Acrylonitrile-Butadiene Rubber (HNBR), Polybutadyene (PR) or natural rubber.

16. A pipe as claimed in claim 14, wherein pipe heating elements are provided within the cover layer.

17. A pipe as claimed in claim 1, wherein a layer of polyethylene is provided as an external layer.

18. A pipe as claimed in claim 17, wherein the polyethylene is Ultra-High Molecular Weight Polyethylene (UhmwPe).

19. A pipe as claimed in claim 1, wherein the carcass is formed from a stainless steel.

20. A pipe as claimed in claim 19, wherein the stainless steel remains tough at temperatures below −160° C.

21. A pipe as claimed in claim 19, wherein the stainless steel is a nickel-based alloy.

22. A pipe as claimed in claim 21, wherein the nickel-based alloy is Inconel®.

23. A pipe as claimed in claim 1, wherein the fluorinated fluoroplastic sheath is fully fluorinated.

24. A pipe as claimed in claim 23, wherein the fully fluorinated fluoroplastic is Fluorinated Ethylene Propylene (FEP), Polytetrafluoroethylene (PTFE), Perfluoroalkoxy polymer resin (PFA) or Perfluoroalkoxy (MFA).

25. A method of manufacturing a flexible pipe for transporting cryogenic fluid, the method comprising the steps of:
(i) providing a hollow metallic carcass defined by an interlocked metallic strip;
(ii) lining a surface of the carcass with a fluorinated fluoroplastic to define an inner pipe;
(iii) surrounding the carcass with a layer of insulating material; and
(iv) surrounding the layer of insulating material with an outer pipe; wherein, the inner pipe is adapted to withstand cryogenic temperatures and pressure loads and the outer pipe is adapted to withstand tensile axial loads.

26. A method of connecting two pipe terminations to facilitate the transportation of cryogenic fluid between the two, the method comprising the steps of:
(i) providing a flexible pipe in accordance with claim 1; and
(ii) connecting the pipe at its distal ends to the pipe terminations.

27-29. (canceled)
